(19) United States
(12) Patent Application Publication
(10) Pub. No.: US 2026/0100600 A1
(43) Pub. Date: Apr. 9, 2026

(54) Charging Device

(71) Applicant: Anker Innovations Technology Co., Ltd., Changsha (CN)

(72) Inventors: Wei Chen, Shenzhen (CN); Songya Chen, Shenzhen (CN); Zhifeng Zhong, Shenzhen (CN)

(21) Appl. No.: 19/344,988

(22) Filed: Sep. 30, 2025

(30) Foreign Application Priority Data
Oct. 8, 2024 (CN) 202422421825.2

(51) Int. Cl. H02J 7/00; H02J 50/00

(52) U.S. Cl. CPC H02J 7/751; H02J 50/005

(57) ABSTRACT

A charging device comprises a housing assembly and a charging assembly. The housing assembly comprises an accommodation cavity and a limiting block disposed in the accommodation cavity. The charging assembly comprises a movable block and charging circuitry. The movable board comprises a movable body and a fitting block disposed on the movable body. The fitting block has a fitting surface. The fitting surface forms an angle with a charging plane on the charging circuitry. The limiting block has a limiting surface. The movable board is configured to extend relative to the accommodation cavity, and the fitting surface is configured to fit the limiting surface to restrict movement of the movable board in a direction perpendicular to an extension direction of the movable board.

### CROSS-REFERENCE TO RELATED APPLICATION

The present disclosure claims priority to CN Application No. 202422421825.2, filed on October 8, 2024. The above application is hereby incorporated in its entirety.

### FIELD

The present disclosure relates to the technical field of charging equipment, particularly to a charging device.

### Background

A charging device can charge electronic devices such as TWS (True Wireless Stereo) earphones, smart phones, and smart watches. By designing the charging structure of the device as a retractable structure, the overall structure of the charging device becomes more compact and convenient for storage. However, to meet the sliding and retractable requirements, such structures generally include gaps, and the presence of these gaps can easily lead to unstable movement of charging components during extension and retraction.

### Summary

The present disclosure provides a charging device that can address a problem of unstable movement of charging components during extension and retraction. The charging device provided by the present disclosure comprises: a housing assembly and a charging assembly. The housing assembly comprises an accommodation cavity and a limiting block disposed in the accommodation cavity. The charging assembly comprises a movable block and charging circuitry. The movable board comprises a movable body and a fitting block disposed on the movable body. The fitting block has a fitting surface. The fitting surface forms an angle with a charging plane on the charging circuitry. The limiting block has a limiting surface. The movable board is configured to extend relative to the accommodation cavity, and the fitting surface is configured to fit the limiting surface to restrict movement of the movable board in a direction perpendicular to an extension direction of the movable board.

According to a charging device of the present disclosure, the limiting surface of the limiting block and the fitting surface of the fitting portion are inclined planes. The fitting surface fits the limiting surface in a first position of the movable board, for example, when the movable board is fully extended. The fitting surface and the limiting surface interact in the extension direction of the movable board to prevent the movable board from separating from the housing assembly and to prevent the movable board from moving relative to the housing assembly in a direction perpendicular to the extension direction of the movable body, thereby providing good resting stability for the electronic device resting against the first charging plane. Thus, when designing the charging device, gaps can be reserved for smooth movement of the movable board relative to the housing assembly, and the movable board can also have good mounting stability for electronic devices to rest against when the movable board extends to the charging position.

### BRIEF DESCRIPTION OF THE DRAWINGS

In order to more clearly illustrate technical solutions in the disclosure, the drawings that need to be used in description of the application are briefly introduced below. Apparently, the accompanying drawings described below are merely some examples of the present disclosure, and for those of ordinary skill in the art, other drawings can be obtained based on these drawings without inventive work.

FIG. 1 is a perspective view of a charging device with a movable member in an extended state according to an example of the present disclosure;

FIG. 2 is a perspective view of a charging device with a movable member in a retracted state according to an example of the present disclosure;

FIG. 3 is a cross-sectional view of a charging device with a movable member in an extended state according to an example of the present disclosure;

FIG. 4 is a perspective view of a middle housing according to an example of the present disclosure;

FIG. 5 is a perspective view of a charging assembly according to an example of the present disclosure;

FIG. 6 is a perspective view of a pre-tightening assembly mounted on a charging assembly and a middle housing according to an example of the present disclosure;

FIG. 7 is a top view of a charging assembly mounted on a second housing according to an example of the present disclosure;

FIG. 8 is a cross-sectional view of a pre-tightening assembly mounted on a charging assembly and a middle housing according to an example of the present disclosure; and

FIG. 9 is a cross-sectional view of a pre-tightening assembly mounted on a charging assembly and a middle housing according to another example of the present disclosure.

### Description of reference signs

10: charging device; 100: housing assembly; 110: housing body; 111: middle housing; 101: accommodation cavity; 1101: front opening; 1102: front wall surface; 1103: rear wall surface; 1104: bottom wall surface; 1111: first housing; 1112: second housing; 112: outer housing; 1121: peripheral wall surface; 1122: accommodation opening; 1011: limiting portion; 1012: limiting surface; 11a: hollow groove; 130: flip cover; 1123: guide rib; 200: charging assembly; 210: movable member; 211: movable body; 2101: upper surface; 2102: lower surface; 2103: side surface; 212: fitting portion; 2121: first fitting block; 2122: second fitting block; 2120: fitting surface; 300: first charging component; 310: first charging plane; 400: second charging component; 410: second charging plane; 500: third charging component; 510: third charging plane; 600: circuit board; 700: interface; 800: ejection assembly; 810: elastic member; 820: limiting rod; 610: press-type latch; 910: first pre-tightening portion; 920: second pre-tightening portion; H: length direction; A: thickness direction; B: width direction.

### DETAILED DESCRIPTION

In order to make the objects, technical solutions, and advantages of the present disclosure more apparent, the present disclosure will be described in detail with reference to the accompanying drawings. It should be understood that the specific examples described herein are only used to explain the disclosure and are not used to limit the disclosure.

The inventors found that an extendable and retractable charging structure of a charging device can make an overall structure of the charging device compact and convenient for storage. However, to meet assembly requirements, the extendable and retractable charging structure generally includes or reserves gaps (e.g., clearances) and the presence of these gaps can easily lead to unstable movement of charging components during extension and retraction. The present disclosure provides examples a charging device that address this problem.

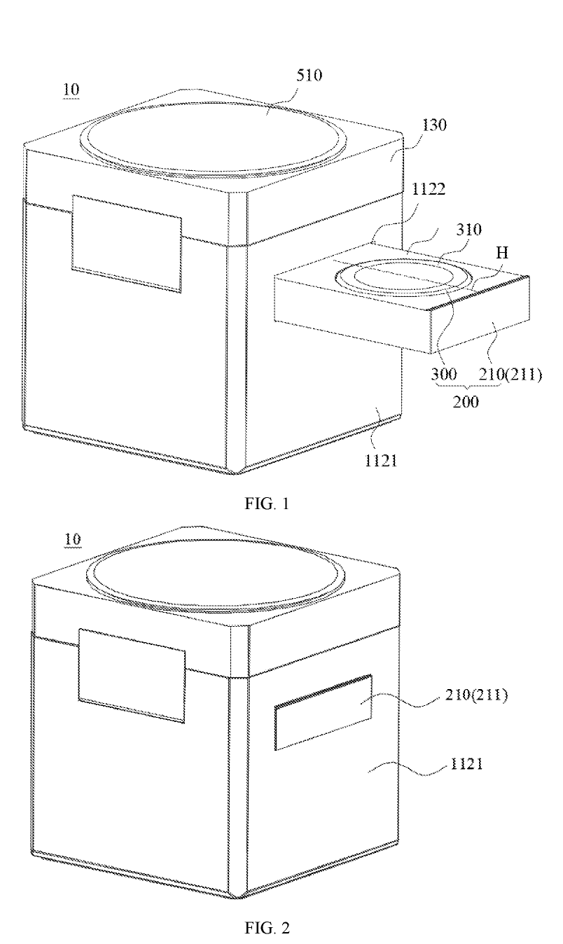

FIG. 1 is a perspective view of a charging device 10 including a housing assembly 100 according to an example of the present disclosure. The housing assembly 100 serves as a basic carrier of the charging device 10, providing support and protection for other components of the charging device 10. The housing assembly 100 has an accommodation cavity inside and an accommodation opening 1122 communicating with the accommodation cavity.

The charging assembly 200 may include a movable member 210 (e.g., a movable board) and a first charging component 300. The movable member 210 may include a movable body 211. The movable member 210 may be movably disposed in the accommodation cavity along a length direction H of the movable body, so that the movable body 211 can extend or retract relative to the accommodation cavity at the accommodation opening 1122. The first charging component 300 may include an outer surface including a first charging plane 310. The first charging plane 310 is parallel to the length direction H of the movable body, and a central axis of the first charging plane 310 is perpendicular to a plane where the accommodation opening 1122 is located. The accommodation opening 1122 is formed on a peripheral wall surface 1121 of the housing assembly 100. For example, the outer contour of the first charging plane 310 may be circular, rectangular, regular polygonal, or the like.

As shown in FIG. 1, when the movable body 211 extends from the accommodation cavity 101, part of the movable body 211 extends outside the housing assembly 100, and the first charging plane 310 extends outside the housing assembly 100, so that an electronic device (e.g., a smart watch) can rest against the first charging plane 310, and the first charging component 300 charges the electronic device resting against the first charging plane 310. As shown in FIG. 2, when the movable member 210 retracts relative to the accommodation cavity 101, the movable body 211 is accommodated in the accommodation cavity 101, and the first charging component 300 is accommodated in the accommodation cavity 101, making the overall structure of the charging device 10 compact and occupy less space without a protruding part, which is convenient to store and carry the charging device 10.

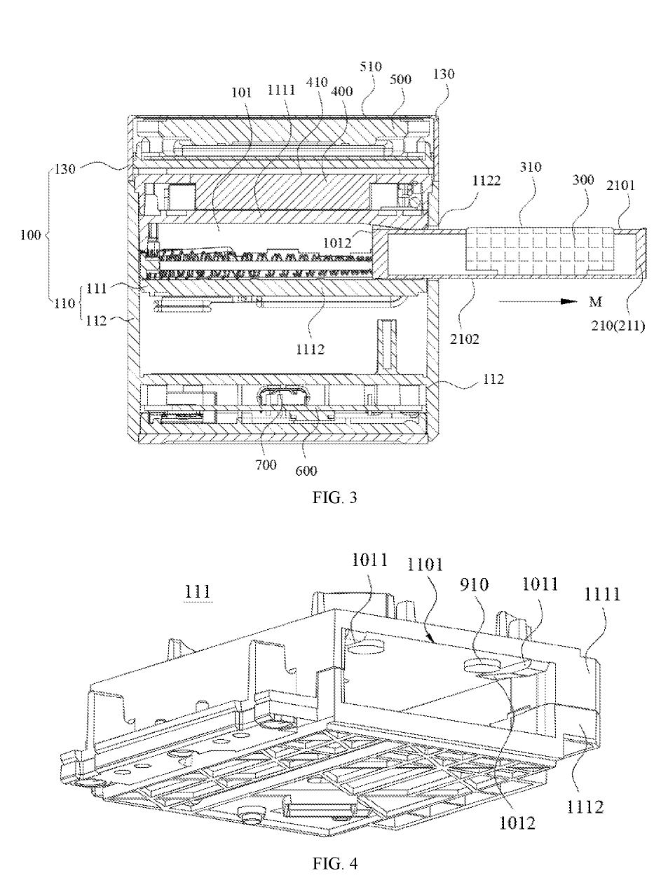

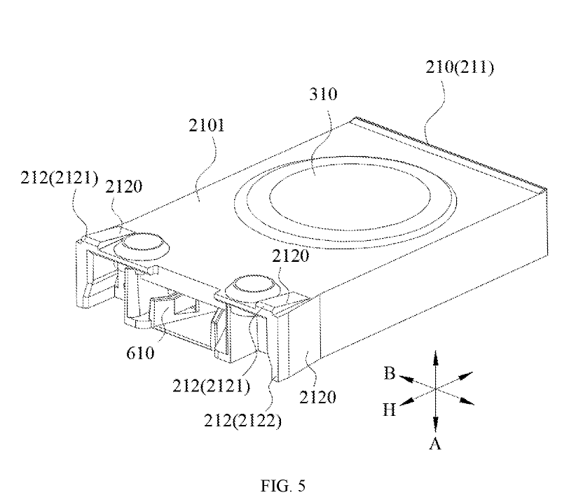

Referring to FIG. 3 and FIG. 4, the housing assembly 100 may include a limiting portion 1011 disposed in the accommodation cavity 101. The limiting portion 1011 has a limiting surface 1012. The movable member 210 may include a fitting portion 212 protruding from an outer surface of the movable body 211. Referring to FIG. 3 and FIG. 5, the fitting portion 212 has a fitting surface 2120. The fitting surface 2120 forms an angle with the first charging plane 310. The movable member 210 has a first position where the movable member 210 extends relative to the accommodation cavity 101. The first position is the maximum position where the movable member 210 extends from the accommodation cavity 101. The limiting surface 1012 can abut against the fitting surface 2120 to prevent the movable member 210 from detaching from the housing assembly 100 when the movable member 210 is in the first position, and to restrict movement of the movable member 210 in a direction perpendicular to the length direction H of the movable body 211.

Since gaps may be reserved between the movable member 210 and a wall surface of the housing assembly 100 defining the accommodation cavity 101 to facilitate smooth movement of the movable member 210 in the accommodation cavity 101, when the extending portion of the movable member 210 rests against an electronic device or is subjected to an external force, the gaps can easily cause the movable member 210 to shake. In an example of the present disclosure, the first position of the movable member 210 may be the optimal charging position, and the limiting surface 1012 of the limiting portion 1011 and the fitting surface 2120 of the fitting portion 212 may be inclined planes to improve stability of the movable member 210 in the first position.

Specifically, the movable member 210 has an extending direction M relative to the accommodation cavity 101 and a retracting direction relative to the accommodation cavity 101. As shown in FIG. 3, in the direction where the movable body 211 extends relative to the accommodation cavity 101, the fitting surface 2120 of the fitting portion 212 inclines toward a side close to the movable body 211. The fitting surface 2120 fits the limiting surface 1012 in the first position of the movable member 210. The fitting surface 2120 and the limiting surface 1012 interact in the length direction H of the movable body to prevent the movable member 210 from separating from the housing assembly 100. Meanwhile, the fitting surface 2120 and the limiting surface 1012 interact in a thickness direction A of the movable body 211 to prevent the movable member 210 from moving relative to the housing assembly 100 in a direction perpendicular to the thickness direction A of the movable body 211. The thickness direction A of the movable body 211 is perpendicular to the first charging plane 310, thereby providing good resting stability for the electronic device resting against the first charging plane 310. Thus, when designing the charging device 10, gaps can be reserved for smooth movement of the movable member 210 relative to the housing assembly 100, while ensuring good mounting stability of the movable member 210 for electronic devices to rest against when the movable member 210 extends to the charging position.

It can be understood that when an electronic device rests against the first charging plane 310, it is beneficial to ensure the mounting stability of the movable member 210 in the direction perpendicular to the first charging plane 310. In some examples, as shown in FIG. 5, the fitting portion 212 may include a first fitting block 2121. The fitting surface 2120 of the first fitting block 2121 forms an angle with a plane perpendicular to the thickness direction A of the movable body 211, so that when the fitting surface 2120 fits the limiting surface 1012, the fitting surface 2120 and the limiting surface 1012 interact in the thickness direction A of the movable body 211 to limit the position of the movable member 210 in the thickness direction A of the movable body 211, providing good resting stability in the thickness direction A of the movable body 211 when the electronic device rests against the first charging plane 310.

In some examples, the thickness direction A of the movable body is the gravity direction. The outer surface of the movable body 211 may include an upper surface 2101 and a lower surface 2102 disposed opposite in the gravity direction. The upper surface 2101 may be provided with an opening for installing the first charging component 300, and the first charging plane 310 of the first charging component 300 is located at the opening of the upper surface 2101. When the movable member 210 extends, a gap between the movable member 210 and the housing assembly 100 in the gravity direction can easily cause the movable member 210 to move in the gravity direction. To address this issue, the first fitting block 2121 is provided, and the housing assembly 100 is provided with a limiting portion 1011 disposed opposite to the first fitting block 2121 in the gravity direction. The limiting surface of the limiting portion 1011 fits the fitting surface 2120 of the first fitting block 2121 to limit the position of the movable member 210 in the gravity direction. The number of first fitting blocks 2121 provided on the upper surface 2101 of the movable body 211 is one or more.

When there is one first fitting block 2121 protruding from the upper surface 2101 of the movable body 211 in the gravity direction, the first fitting block 2121 may be located behind the first charging plane 310 in the direction M where the movable body 211 extends relative to the accommodation cavity 101 (e.g., on a side of the first charging plane 310). Furthermore, the first fitting block 2121 may extend along the width direction B of the movable body and is strip-shaped. The width direction B of the movable body may be parallel to the first charging plane 310 and perpendicular to the thickness direction A of the movable body, increasing the size of the fitting surface 2120 of the first fitting block 2121. The number of limiting portions 1011 corresponding to the fitting surface 2120 of the first fitting block 2121 may be one or more. When there is one limiting portion, the size of the limiting surface 1012 of the limiting portion 1011 in the width direction B of the movable body may be the same as the size of the fitting surface 2120 of the first fitting block 2121 and two ends of the limiting surface 1012 and the fitting surface 2120 are aligned. When there are a plurality of limiting portions, a plurality of limiting portions 1011 are spaced apart and evenly distributed in the width direction B of the movable body.

When there are a plurality of first fitting blocks 2121 on the upper surface 2101 of the movable body 211 in the gravity direction, the plurality of first fitting blocks 2121 may be located behind the first charging plane 310 and spaced apart in the width direction B of the movable body in the direction M where the movable body 211 extends relative to the accommodation cavity 101. The number of limiting portions 1011 corresponding to the plurality of first fitting blocks 2121 may be one or more. When there is one limiting portion, the limiting surface 1012 of the limiting portion 1011 may fit the fitting surfaces 2120 of the plurality of first fitting blocks 2121. When there are a plurality of limiting portions, the limiting surfaces 1012 of the plurality of limiting portions 1011 correspond to and fit the fitting surfaces 2120 of the plurality of first fitting blocks 2121 respectively.

In some examples, all of the first fitting blocks 2121 may be disposed on the upper surface 2101 of the movable body 211. The housing assembly 100 has a front opening 1101 communicating with the accommodation cavity 101. The movable body 211 passes through the front opening 1101 and the accommodation opening 1122 in sequence. The lower surface 2102 of the movable body 211 rests against a wall surface of the housing assembly 100 defining the front opening 1101. When the movable member 210 is in the first position where the movable member 210 extends, the fitting surface 2120 of the first fitting block 2121 fits the limiting surface 1012 of the limiting portion 1011, thereby limiting the position of the movable member 210 in the gravity direction.

In some other examples, some of the first fitting blocks 2121 may protrude from the upper surface 2101 of the movable body 211, while other first fitting blocks 2121 may protrude from the lower surface 2102 of the movable body 211. The housing assembly 100 may be provided with limiting portions 1011 corresponding to the first fitting blocks 2121, thereby further restricting the stability of the movable member 210 in the gravity direction when the movable member 210 is in the first position where the movable member 210 extends.

In some examples, the housing assembly 100 may include a middle housing 111. The middle housing 111 may have the accommodation cavity 101 and the front opening 1101 communicating with the accommodation cavity 101. The front opening 1101 corresponds to the accommodation opening 1122, and the movable member 210 passes through the front opening 1101 and the accommodation opening 1122 sequentially from the accommodation cavity 101 and extends from the housing assembly 100. A wall surface of the middle housing 111 defining the accommodation cavity 101 may include a top wall surface 1105 and a bottom wall surface 1104. The top wall surface 1105 and the bottom wall surface 1104 are disposed opposite in the thickness direction A of the movable body. The upper surface 2101 and the lower surface 2102 of the movable body 211 slidably fit the wall surface of the middle housing 111 defining the front opening 1101 separately. The first fitting block 2121 protruding from the upper surface 2101 of the movable body 211 slidably fits the top wall surface 1105 of the middle housing 111. When the first fitting block 2121 protrudes from the lower surface 2102 of the movable body 211, the first fitting block 2121 slidably fits a wall surface of the bottom wall surface 1104 of the middle housing 111. Thus, through the interaction between the wall surfaces during movement of the movable member 210 relative to the accommodation cavity 101, the movable member 210 can move smoothly along the length direction H of the movable body, with small contact area and small sliding resistance. Due to assembly tolerances and sliding requirements, there inevitably are certain clearances at the sliding fit positions between the wall surfaces. When the movable member 210 is in the extending state, through the fitting of the fitting surface 2120 of the first fitting block 2121 with the limiting surface 1012 of the limiting portion 1011, the sliding fit positions are no longer affected by the clearances, and the movable member can directly have good mounting stability in the gravity direction when the movable member 210 extends.

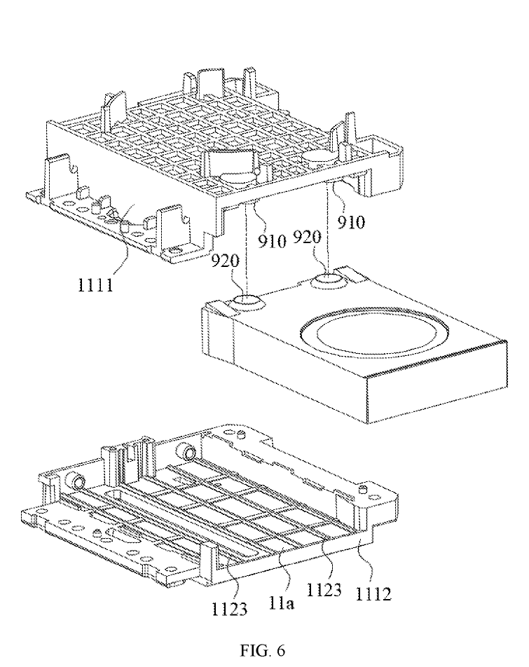

Due to gravity, the movable member 210 needs to rest against the bottom wall surface 1104 of the accommodation cavity 101. In some examples, as shown in FIG. 6, a plurality of hollow grooves 11 are formed in the bottom wall surface 1104 to reduce the contact area between the movable body 211 and the bottom wall surface 1104, facilitating smooth movement of the movable member 210. In other examples, when no first fitting block 2121 is provided on the lower surface 2102 of the movable body 211, one of the bottom wall surface 1104 and the lower surface 2102 of the movable body 211 is provided with guide grooves, and the other is provided with guide ribs 1123. The guide grooves may extend along the length direction H of the movable body 211, and the guide ribs 1123 are slidably disposed in the guide grooves to guide the movement of the movable member 210 along the length direction H of the movable body. As shown in FIG. 6, a protruding bar is formed between two adjacent hollow grooves 11a on the bottom wall surface 1104. Two protruding bars form two guide ribs 1123, and guide grooves respectively corresponding to the two guide ribs 1123 are formed in the lower surface 2102 of the movable body 211.

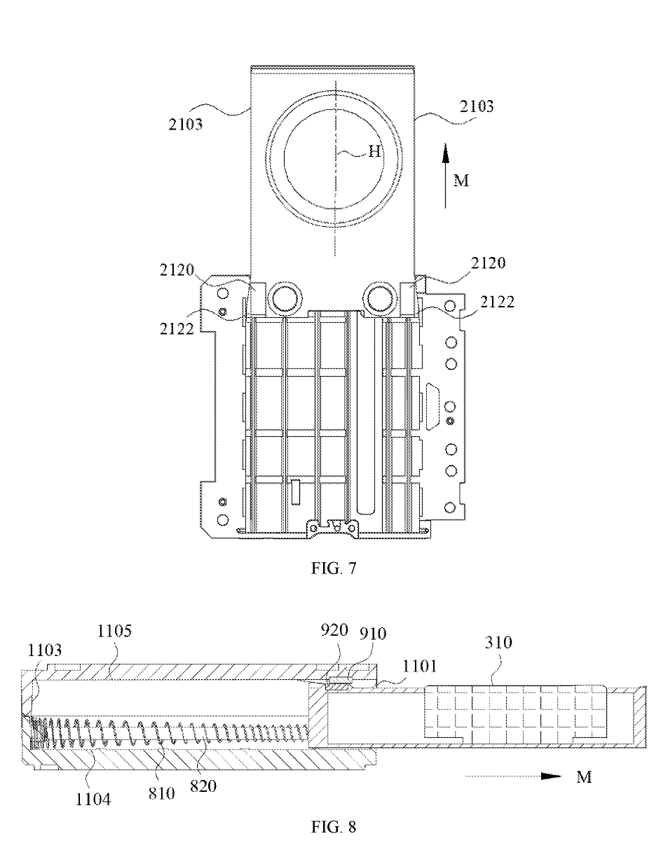

In some examples, as shown in FIG. 7, there are a plurality of first fitting blocks 2121, and the fitting surfaces 2120 of the plurality of first fitting blocks 2121 are axially symmetrical about a first plane. The first plane passes through the central axis of the first charging plane 310 and is perpendicular to the first charging plane 310. When the fitting surfaces 2120 of the plurality of first fitting blocks 2121 fit the corresponding limiting surfaces 1012 of the limiting portions 1011, forces are evenly distributed, providing better limiting stability for the movable member 210. Similarly, when there is only one first fitting block 2121, the fitting surfaces 2120 of the first fitting blocks 2121 are also axially symmetrical about the first plane.

In some examples, the fitting portion 212 may include a second fitting block 2122. A fitting surface 2120 of the second fitting block 2122 forms an angle with a plane perpendicular to the width direction B of the movable body 211. The housing assembly 100 has a limiting portion 1011 corresponding to the second fitting block 2122. When the movable member 210 extends to the first position, the fitting surface 2120 of the second fitting block 2122 fits the limiting surface 1012 of the corresponding limiting portion 1011 to limit the position of the movable member 210 in the width direction B of the movable body.

In some examples, the contour of a cross section of the movable body 211 in a direction perpendicular to the length direction H of the movable body may be rectangular. Specifically, the movable body 211 includes two side surfaces 2103 disposed opposite in the width direction B of the movable body. Each of the side surfaces 2103 is connected between the upper surface 2101 and the lower surface 2102 of the movable body 211. There are a plurality of second fitting blocks 2122. In the width direction B of the movable body, some of the second fitting blocks 2122 protrude from one side surface 2103 of the movable body 211, while the other second fitting blocks 2122 protrude from the other side surface 2103 of the movable body 211. In a direction where the movable body 211 extends relative to the accommodation cavity 101, the fitting surfaces 2120 of the second fitting blocks 2122 disposed on opposite sides of the movable body 211 approach each other. The second fitting block 2122 fits the first fitting block 2121 to limit the position of the movable member 210 in the first position from multiple directions, further improving mounting stability of the movable member 210 in the first position. Meanwhile, addition of the second fitting block 2122 can increase the interaction area between the movable member 210 and the housing assembly 100, improve structural strength, prevent the small area when only the first fitting block 2121 acts on the housing assembly 100, and prevent separation of the movable member 210 from the housing assembly 100.

In some examples, in the width direction B of the movable body, the fitting surface 2120 of the second fitting block 2122 disposed on one side of the movable body 211 is axially symmetrical about the first plane with the fitting surface 2120 of the second fitting block 2122 disposed on the other side of the movable body 211, further improving the limiting stability of the second fitting blocks 2122 on the movable member 210 in the width direction B of the movable body. A wall surface of the middle housing 111 defining the accommodation cavity 101 further includes a left wall surface 1105 and a right wall surface 1104. During the movement of the movable member 210 along the length direction H of the movable body, the second fitting block 2122 on one side of the movable body 211 slidably fits the left wall surface 1105, and the second fitting block 2122 on the other side of the movable body 211 slidably fits the right wall surface 1104. The two side surfaces 2103 of the movable body 211 separately slidably fit the wall surface of the middle housing 111 defining the front opening 1101, reducing the contact area to allow smooth sliding of the movable member 210, and guiding movement of the movable member 210 in the length direction H of the movable body. Similarly, due to sliding requirements and assembly clearances, there are certain clearances between the wall surfaces at the slidable fitting positions. When the movable member 210 is in the first position, the fitting surface 2120 of the second fitting block 2122 fits the limiting surface 1012 of the corresponding limiting portion 1011, which may not be affected by the clearances, limiting the position of the movable member 210 in the width direction B of the movable body.

In some examples, the charging device 10 may further include a press-type locking assembly and an ejection assembly 800. The press-type locking assembly is configured to lock the position of the movable member 210 relative to the accommodation cavity 101 when the movable member 210 retracts into the accommodation cavity 101. After the press-type locking assembly releases the lock on the movable member 210, the ejection assembly 800 pushes the movable member 210 to move along the length direction H of the movable body and extend relative to the housing assembly 100. There may be multiple sets of ejection assemblies 800 axially symmetrical about the first plane. The fitting surfaces 2120 of the second fitting blocks 2122 disposed on opposite sides of the movable body 211 are also axially symmetrical about the first plane. Thus, when multiple sets of ejection assemblies 800 push out the movable member 210, forces exerted on the housing assembly 100 by the second fitting blocks 2122 disposed on opposite sides of the movable body 211 are more even, preventing the movable member 210 from swaying in the plane of the first charging plane 310 due to uneven forces exerted on the housing assembly 100 by the movable body 211.

In some examples, the ejection assembly 800 includes an elastic member 810. The elastic member 810 pushes the movable body 211 to extend relative to the accommodation cavity 101 through an elastic recovery force of the elastic member 810. A wall surface of the housing assembly 100 defining the accommodation cavity 101 includes a front wall surface 1102 and a rear wall surface 1103. The front wall surface 1102 and the rear wall surface 1103 are disposed opposite in the length direction H of the movable body. The front wall surface 1102 is provided with a front opening 1101. One end of the elastic member 810 may be installed on the rear wall surface 1103, and the other end thereof may face the front wall surface 1102. When the press-type locking assembly releases the lock on the movable member 210, the elastic member 810 extends to recover elastic deformation thereof, pushing out the movable member 210 to extend relative to the housing assembly 100. Alternatively, one end of the elastic member 810 may be installed on the front wall surface 1102, and the other end thereof may face the rear wall surface 1103. When the press-type locking assembly releases the lock on the movable member 210, the elastic member 810 contracts to recover elastic deformation thereof, pulling back the movable member 210 to extend relative to the housing assembly 100.

In some examples, the ejection assembly 800 may further include a limiting rod 820. The movable body 211 has a plurality of limiting holes facing the rear wall surface 1103. The plurality of limiting holes are disposed corresponding to the limiting rods 820 of a plurality of elastic assemblies. The axis of the limiting rod 820 is parallel to the length direction H of the movable body. One end of the limiting rod 820 is installed on the rear wall surface 1103, and the other end thereof extends into the limiting hole of the movable body 211. An outer surface of the limiting rod 820 slidably fits the wall surface of the movable body 211 defining the limiting hole, guiding the movement of the movable member 210 along the length direction H of the movable body. The elastic member 810 may be a tension and compression spring which fits around the periphery of the limiting rod 820, and the limiting rod 820 guides the tension and compression spring to be tensioned and compressed along the length direction H of the movable body.

As shown in FIG. 6, the charging device 10 may further include a pre-tightening assembly. The pre-tightening assembly includes a first pre-tightening portion 910 and a second pre-tightening portion 920. The first pre-tightening portion 910 is installed on the housing assembly 100, and the second pre-tightening portion 920 is installed on the movable body 211. The first pre-tightening portion 910 fits the second pre-tightening portion 920 to cause the fitting surface 2120 of the fitting portion 212 to abut against the limiting surface 1012 of the limiting portion 1011, which limits the position of the movable member 210 in the length direction H of the movable body, prevents retraction of the movable member under slight external force, and meanwhile improves tightness of fit between the fitting surface 2120 and the limiting surface 1012, so as to further improve a position of the movable member 210 in a direction perpendicular to a preset central axis, enhancing mounting stability of the movable member 210 in the first position.

In some examples, one of the first pre-tightening portion 910 and the second pre-tightening portion 920 is magnetic, while the other is either magnetic or contains iron material. The first pre-tightening portion 910 and the second pre-tightening portion 920 abut the limiting surface 1012 of the limiting portion 1011 against the fitting surface 2120 of the fitting portion 212 through magnetic action, while facilitating application of a certain force to retract the movable member 210 into the accommodation cavity 101.

The first pre-tightening portion 910 has a first top 911 and a second top 912 disposed opposite along the length direction H of the movable body. In the direction M where the movable member 210 extends relative to the accommodation cavity 10a, the first top 911 is located in front of the second top 912.

In some examples, when the first pre-tightening portion 910 and the second pre-tightening portion 920 cause the limiting surface 1012 to abut against the fitting surface 2120 through a magnetic attraction force, the first pre-tightening portion 910 is magnetic, with a magnetic center thereof located at the first top 911. In the direction M where the movable body 211 extends relative to the accommodation cavity 101, the first top 911 is located in front of the second pre-tightening portion 920. The magnetic attraction force between the first pre-tightening portion 910 and the second pre-tightening portion 920 can pull the second pre-tightening portion 920 to approach the first pre-tightening portion 910, causing the limiting surface 1012 to abut against the fitting surface 2120. At this time, the second pre-tightening portion 920 may or may not be magnetic.

In some examples, as shown in FIG. 8, in the direction where the movable body 211 extends relative to the accommodation cavity 101, a distance from the second top 912 to the front opening 1101 may be set smaller than a distance from the second top 912 to the rear wall surface 1103. The area covered by the first pre-tightening portion 910 in the movement direction of the movable member 210 is small. At this time, after the second pre-tightening portion 920 moves to the area near the first pre-tightening portion 910, the limiting surface 1012 abuts against the fitting surface 2120 through the magnetic attraction force. For example, when the elastic assembly includes the elastic member 810, the elastic member 810 can push the movable member 210 to cause the second pre-tightening portion 920 to move to the area near the first pre-tightening portion 910. During the entire movement of the movable member 210, the elastic member 810 is connected to the movable body 211.

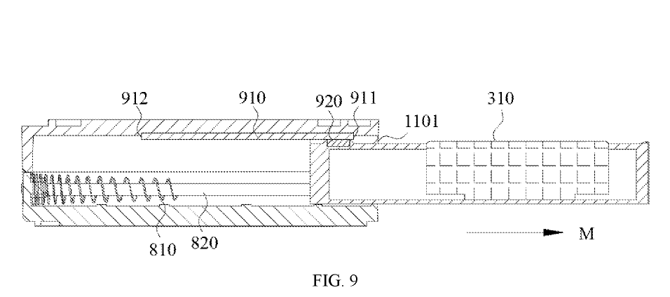

In some examples, as shown in FIG. 9, in the direction M where the movable body 211 extends relative to the accommodation cavity 101, the distance from the second top 912 to the front opening 1101 is greater than or equal to the distance from the second top 912 to the rear wall surface 1103. The first pre-tightening portion 910 is magnetic, with a magnetic center thereof located at the first top 911. This allows the area covered by the first pre-tightening portion 910 in the movement direction of the movable member 210 to be large, and allows the second pre-tightening portion to be attracted by the first pre-tightening portion 910 when the second pre-tightening portion is far from the front opening 1101. Then, under the magnetic attraction force between the first pre-tightening portion and the second pre-tightening portion, the movable member 210 is driven to extend from the accommodation cavity 101. For example, when the elastic assembly includes an elastic member 810, the elastic member 810 can provide a boost force to cause the movable member 210 to start moving, then the magnetic attraction force between the first pre-tightening portion 910 and the second pre-tightening portion 920 drives the second pre-tightening portion 920 to move toward the magnetic center of the first pre-tightening portion 910, thereby driving the movable member 210 to extend from the accommodation cavity 101. During the movement of the movable member 210, the elastic member 810 may separate from the movable member 210, and the second pre-tightening portion 920 moves toward an end close to the magnetic center of the first pre-tightening portion 910, thereby abutting the limiting surface 1012 against the fitting surface 2120.

In other examples, in the direction where the movable body 211 extends relative to the accommodation cavity 101, when the distance from the second top 912 to the front opening 1101 is less than the distance from the second top 912 to the rear wall surface 1103, the elastic member 810 may be set to have a short length, and the elastic member 810 separates from the movable member 210 while the movable member 210 is extending from the accommodation cavity 101. Alternatively, in the direction where the movable body 211 extends relative to the accommodation cavity 101, when the distance from the second top 912 to the front opening 1101 is greater than or equal to the distance from the second top 912 to the rear wall surface 1103, the elastic member 810 may be set to have a long length, and maintains connection with the movable member 210 throughout the entire movement of the movable member 210.

In other examples, the first pre-tightening portion 910 may be set to be non-magnetic. In the direction M where the movable body 211 extends relative to the accommodation cavity 101, the first top 911 is located in front of the second pre-tightening portion 920. Similarly, the magnetic attraction force between the first pre-tightening portion 910 and the second pre-tightening portion 920 can pull the second pre-tightening portion 920 to approach the first pre-tightening portion 910, causing the limiting surface 1012 to abut against the fitting surface 2120.

In some examples, the first pre-tightening portion 910 and the second pre-tightening portion 920 are magnetic, and cause the limiting surface 1012 to abut against the fitting surface 2120 through a magnetic repulsion force. For example, the second pre-tightening portion 920 is disposed at a position near the rear wall surface of the housing assembly 100, so that the magnetic repulsion force between the first pre-tightening portion 910 and the second pre-tightening portion 920 pushes the movable member 210 out of the accommodation cavity 10a along the length direction of the movable body. This example of the present disclosure does not limit the position where the first pre-tightening portion 910 is installed on the housing assembly 100. The installation position of the first pre-tightening portion 910 may only need to meet subsequent conditions: the direction in which the magnetic repulsion force between the first pre-tightening portion 910 and the second pre-tightening portion 920 pushes the movable member 210 to move is the same as the direction in which the elastic assembly pushes the movable member 210 to move, so that when the movable body 211 is in the first position, the limiting surface 1012 can abut against the fitting surface 2120.

In some examples, the press-type locking assembly may include a press-type latch 610 and a snap. The press-type latch 610 is located on the movable member 210, and the snap is located in the accommodation cavity 101. The press-type latch 610 adopts a self-locking design. When the press-type latch 610 is pressed toward the snap, the press-type latch 610 can fit and lock with the snap, and when the press-type latch 610 is pressed toward the snap again, the press-type latch 610 can release the snap, thus releasing the lock. For example, when the movable member 210 is retracted into the accommodation cavity 101, the press-type latch 610 fits the snap to lock the movable member 210. By pressing the movable member 210, the press-type latch 610 is pressed toward the snap, the press-type latch 610 releases the lock with the snap, and the movable member 210 extends from the accommodation cavity 101 under driving of the elastic member 810. When the movable member 210 needs to be stored, the movable member 210 is pressed back into the accommodation cavity 101, the press-type latch 610 is pressed toward the snap again, and the press-type latch 610 fits the snap again to lock the movable member 210. It should be noted that the self-locking design of the press-type latch 610 is within the scope of understanding of those skilled in the art and will not be described here.

In some examples, the middle housing 111 with the accommodation cavity 101 includes a first housing 1111 and a second housing 1112. The first housing 1111 and the second housing 1112 are disposed opposite along the thickness direction A of the movable body and jointly define the accommodation cavity 101 and the front opening 1101 communicating with the accommodation cavity 101. At least one of the first housing 1111 and the second housing 1112 has a limiting portion 1011. The split design of the middle housing 111 facilitates both processing of the middle housing 111 and installation of structural members such as the movable member 210 and the elastic assembly in the accommodation cavity 101.

The housing assembly 100 includes the housing body 110. The charging assembly 200 is disposed in the housing body 110. The housing body 110 includes a peripheral wall surface 1121. The peripheral wall surface 1121 is provided with an accommodation opening 1122 corresponding to the front opening 1101, allowing the accommodation opening 1122 to communicate with the accommodation cavity 101. The movable body 211 passes through the accommodation opening 1122 to extend or retract relative to the accommodation cavity 101, allowing the part of the movable member 210 extending from the housing assembly 100 to be positioned on a side of the housing assembly 100. Specifically, the housing body 110 includes an outer housing 112 and a middle housing 111. The middle housing 111 is disposed within the internal space of the outer housing 112, and the peripheral wall surface of the outer housing 112 is the peripheral wall surface 1121 of the housing body 110.

The first charging component 300 of the charging assembly 200 is disposed inside the movable body 211 to charge electronic devices placed on the first charging plane 310. During arrangement of the charging assembly 200, positions of structural members such as the movable member 210 and the first charging component 300 of the charging assembly 200 can be arranged based on weight, ensuring that the overall weight of the charging assembly 200 is distributed symmetrical about the preset central axis.

The charging device 10 further includes a second charging component 400 with a second charging plane 410 configured to charge electronic devices placed on the second charging plane 410. In the thickness direction A of the movable body 211, part of the second charging component 400 is installed inside the housing body 211 and is positioned on one side of the first charging component 300. The second charging component 400 has the second charging plane 410 exposed on the outer surface of the housing body and is configured to charge electronic devices placed on the second charging plane 410. For example, referring again to FIG. 3, the second charging component 400 is located above the first charging component 300 in the gravity direction. The housing body 110 further includes a middle wall with an opening on the outer surface configured to install the second charging component 400, allowing the second charging plane 410 to be exposed on the outer surface of the housing body 110.

The charging device 10 may further include a third charging component 500 with a third charging plane 510 configured to charge electronic devices placed on the third charging plane 510. The housing assembly 100 may further include a flip cover 130 that is rotatably mounted on the housing body 110 relative to the middle wall. The flip cover 130 has a top wall facing away from the middle wall with an opening configured to accommodate the third charging component 500, allowing the third charging plane 510 to be exposed on the outer surface of the flip cover 130. The flip cover 130 has an open state and a closed state. In the closed state, the flip cover 130 is located above the housing body 110. In the open state, the flip cover 130 is disposed at an angle relative to the second charging plane 410 to expose the second charging plane 410, so that electronic devices can be placed on the second charging plane 410 for charging.

In this example of the disclosure, the first charging component 300, second charging component 400, and third charging component 500 may be wireless charging components capable of charging electronic devices such as smart watches through wireless charging. The first charging component 300, second charging component 400, and third charging component 500 can support MagSafe charging connection technology or the like. Electronic devices with magnetic attraction functionality can be automatically attracted to the corresponding charging components and establish electrical connections for charging by approaching to the first charging component 300, second charging component 400, and third charging component 500.

The first charging component 300, second charging component 400, and third charging component 500 are configured to charge different electronic devices. For example, the first charging component 300, second charging component 400, and third charging component 500 can simultaneously charge three electronic devices. For example, by operating the movable member 210 of the charging assembly 200 to pop out of the housing assembly 100, a smart watch can be placed on the first charging plane 310 to be charged by the first charging component 300; by closing the flip cover 130, a smartphone can be placed on the third charging plane 510 of the flip cover 130 to be charged by the third charging component 500; by opening the flip cover 130, the second charging plane 410 of the housing body 110 can be vacated, and earphones (such as TWS earphones) can be placed on the second charging plane 410 and charged by the second charging component 400. The compact structure of the first charging component 300, second charging component 400, and third charging component 500 results in a small overall volume of the charging device 10, occupying a small space. In other words, the charging device 10 of this example achieves a three-in-one charging module design for smart watches, smartphones, and earphones in a small volume.

In an example, the charging device 10 may further include a circuit board 600 and a power interface 700. The circuit board 600 is disposed within the internal space of the housing assembly 100 and is electrically connected to the power interface 700. Additionally, the first charging component 300, second charging component 400, and third charging component 500 are all electrically connected to the circuit board 600. The power interface 700 may be further configured to connect to an external power source to transfer electrical power from the external power source to the first charging component 300, second charging component 400, and third charging component 500 separately through the circuit board 600.

In an example, the charging device 10 may be not provided with a power source. The first charging component 300, second charging component 400, and third charging component 500 may all need to be electrically connected to an external power source through the circuit board 600 and power interface 700 to charge electronic devices with power from the external power source. In other examples, a power source may be installed inside the housing assembly 100 of the charging device 10 to supply power to the first charging component 300, second charging component 400, and third charging component 500 to charge electronic devices, which is not limited here.

The same or similar reference signs in the drawings correspond to the same or similar parts. In the description of the present disclosure, it should be understood that the terms “upper”, “lower”, “left”, “right”, and the like indicating orientation or position relationships are based on orientation or position relationships shown in the drawings, and are intended to describe the disclosure and simplify descriptions only and not to indicate or imply that the referred device or element must be provided, configured and operated in a particular orientation. Therefore, the terms used to describe position relationships are intended to be illustrative only and are not intended to limit the present disclosure. For those skilled in the art, specific meanings of the above terms can be understood according to specific situations.

The above are only some examples of the present disclosure and are not intended to limit the disclosure. Any modifications, equivalent substitutions, improvements or the like within the spirit and principle of the disclosure should be included in the scope of the disclosure.

What is claimed is:

1. A charging device comprising:
a housing assembly comprising an accommodation cavity and a limiting block disposed in the accommodation cavity; and
a charging assembly comprising a movable board and charging circuitry, wherein:
the movable board comprises a movable body and a fitting block disposed on the movable body,
the charging circuitry is on the movable body and has a charging plane,
the limiting block has a limiting surface, and the fitting block has a fitting surface,
the fitting surface forms an angle with the charging plane,
the movable board is configured to extend relative to the accommodation cavity, and
the fitting surface is configured to fit the limiting surface to restrict movement of the movable board in a direction perpendicular to an extension direction of the movable board.

2. The charging device of claim 1, wherein:
the fitting surface forms an angle with a plane perpendicular to a thickness direction of the movable board; and
the thickness direction of the movable body is perpendicular to the charging plane.

3. The charging device of claim 1, wherein:
the movable board comprises an upper surface and a lower surface;
the fitting block protrudes from the upper surface; and
the housing assembly has a front opening communicating with the accommodation cavity, the movable board is configured to pass through the front opening, and the lower surface of the movable body rests against a bottom wall surface of the housing assembly.

4. The charging device of claim 3, wherein:
one of the bottom wall surface and the lower surface of the movable board comprises guide grooves, and the other one of the bottom wall surface and the lower surface of the movable board comprises guide ribs,
the guide grooves extend along the extension direction of the movable board, and the guide ribs are slidably disposed in the guide grooves to guide movement of the movable board along the extension direction of the movable board.

5. The charging device of claim 2, further comprising a plurality of fitting blocks, and fitting surfaces of the plurality of fitting blocks are axially symmetrical about a plane, and the plane passes through a central axis of the charging plane and is perpendicular to the charging plane.

6. The charging device of claim 1, further comprising a second fitting block, wherein:
a fitting surface of the second fitting block forms an angle with a plane perpendicular to a width direction of the movable board , and
the width direction of the movable board is parallel to the charging plane and perpendicular to the extension direction of the movable board.

7. The charging device of claim 6, further comprising a plurality of second fitting blocks arranged in the width direction of the movable board, wherein a first subset of the plurality of second fitting blocks protrude from one side surface of the movable board, and the a second subset of the plurality of second fitting blocks protrude from another side surface of the movable board.

8. The charging device of claim 1, wherein the fitting surface of the fitting block inclines towards a side close to the movable board along the extension direction.

9. The charging device of claim 1, further comprising:
a plurality of ejection assemblies arranged in axial symmetry with respect to a plane, wherein:
the plane passes through a central axis of the charging plane and is perpendicular to the charging plane, and
each of the plurality of ejection assemblies comprises a spring, wherein the springs are configured to push the movable board to extend relative to the accommodation cavity.

10. The charging device of claim 1, further comprising:
a pre-tightening assembly comprising a first magnetic and a second magnetic, wherein the first magnetic is on the housing assembly, and the second magnetic is on the movable body; and
wherein the first magnetic and the second magnetic are mutually attracted or repulsive to cause the limiting block to abut against the fitting surface.

11. The charging device of claim 1, wherein the fitting surface is configured to contact the limiting block to restrict movement of the movable board in a direction perpendicular to the extension direction of the movable board.

12. The charging device of claim 10, wherein the first magnetic has a first top and a second top disposed opposite along the extension direction of the movable board, and the first top is located in front of the second top in a direction where the movable board extends relative to the accommodation cavity; and
when a magnetic attraction force occurs between the first magnetic and the second magnetic, the first top is located in front of the second magnetic.

13. The charging device of claim 1, wherein
the housing assembly comprises a housing body and a flip cover,
the charging device further comprises second charging circuitry at least partially located inside the housing body,
the second charging circuitry has a second charging plane exposed on an outer surface of the housing body and is configured to charge an electronic device placed on the second charging plane,
the charging device further comprises third charging circuitry on the flip cover,
the flip cover is rotatably mounted on the housing body relative to the second charging plane, and
the third charging circuitry is configured to charge another electronic device placed on the third charging plane.

14. A charging device comprising:
a housing assembly comprising an accommodation cavity and a limiting block disposed in the accommodation cavity; and
a movable board comprising charging circuitry, a movable body, and a fitting block disposed on the movable body,
the movable board is configured to extend relative to the accommodation cavity, and
the fitting block is configured to contact the limiting block to restrict movement of the movable board in a direction perpendicular to an extension direction of the movable board.

15. The charging device of claim 14, wherein:
the charging circuitry is on the movable body and has a charging plane, and
a fitting surface of the fitting block forms an angle with the charging plane.

16. The charging device of claim 14, wherein a fitting surface of the fitting block inclines towards a side close to the movable board along the extension direction.

17. The charging device of claim 14, wherein the fitting block is located at a side of the movable board.

18. The charging device of claim 14, further comprising:
a first magnetic and a second magnetic, wherein the first magnetic is on the housing assembly, and the second magnetic is on the movable body; and
wherein the first magnetic and the second magnetic are mutually attracted or repulsive to cause the limiting block to abut against the fitting block.

19. The charging device of claim 14, wherein:
the movable board comprises an upper surface and a lower surface, and
the fitting block protrudes from the upper surface.

20. The charging device of claim 19, wherein the housing assembly has a front opening communicating with the accommodation cavity,
the movable board is configured to pass through the front opening, and
the lower surface of the movable body rests against a bottom wall surface of the housing assembly.
